(19) United States
(12) Patent Application Publication
(10) Pub. No.: US 2010/0063925 A1
(43) Pub. Date: Mar. 11, 2010

(54) METHOD AND SYSTEM FOR PERFORMING LEGAL SERVICES OVER THE INTERNET

(75) Inventor: Robert L. Heston, JR., Houston, TX (US)

Correspondence Address: FULBRIGHT & JAWORSKI, LLP, 1301 MCKINNEY, SUITE 5100, HOUSTON, TX, 77010-3095, US

(73) Assignee: LEGAL ACCESS PLANS, INC., Houston, TX (US)

(21) Appl. No.: 12/578,117

(22) Filed: Oct. 13, 2009

Related U.S. Application Data
(63) Continuation of application No. 11/622,946, filed on Jan. 12, 2007, now abandoned.
Application No. 11/622,946 is a division of application No. 09/900,281, filed on Jul. 6, 2001, now abandoned.
(60) Provisional application No. 60/216,646, filed on Jul. 7, 2000.

(51) Int. Cl. G06Q 50/00; G06Q 20/00; G06F 15/16

(52) U.S. Cl. 705/40; 705/311; 709/203

(57) ABSTRACT

A method and system for rendering certain types of legal services, by licensed and practicing lawyers, to clients and potential clients of a law firm. The method and system comprises certain client-software components and server computers which facilitate the acquisition of information entered by the client and specific legal service requests and server-software components which receive, process and store the client's information performing in whole or in part various legal services.

This application claims the benefit of the filing date of Provisional Application Ser. No. 60/216,646 filed Jul. 7, 2000, now pending (hereby incorporated by reference for all purposes).

### FIELD OF THE INVENTION

The present invention relates to providing certain legal services over the Internet by licensed legal entities.

### BACKGROUND OF THE INVENTION

The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transport Protocol (“HTTP”) request or Secure HTTP request (“HTTPS”). The request is forwarded to the Web server that supports that Web page. When that Web server receives the request, it sends that Web page to the client computer system. When the client computer system receives that Web page, it typically displays the Web page using a browser. A browser is a special-purpose application program that effects the requesting of Web pages and the displaying of Web pages.

Currently, Web pages are typically defined using HyperText Markup Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

### SUMMARY OF THE INVENTION

An embodiment of the present invention provides a method and system for rendering certain types of legal services, by licensed and practicing lawyers, to clients and potential clients of a law firm. The method and system comprises certain client-software components which facilitate the acquisition of information entered by the client and specific legal service requests and server-software components which receive, process and store the client's information performing in whole or in part various legal services. The inventive system provides secure communication between the client Web browser and server though commonly used means of secured transmission of data, such as HTTPS.

The invention is hosted on a server computer system that essentially enables the client logging on to visit the firm's virtual reception area via a web browser. At the virtual reception area, the client greeted by a virtual receptionist that allows the client to chose from a collection of tasks and services available or offered by that law firm. The client may select between a variety of Internet-friendly legal tasks, and by making choices from prescribed fields, the client can “tell the virtual receptionist” what task or service they would like to undertake.

In one embodiment, when a prospective client logs onto a web site, based on the client's state of origin, the site will automatically link the client to the correct state. For example, if a resident of California logs onto a Texas web site hosting the invention, the Texas web site will automatically send the client to a web site residing in California so that a licensed California attorney may provide services to the client.

Once a service is selected, the client then interacts with the system by providing various information or searching for topics related to areas of interest to the client. The services are further delineated by prescribed fields giving them choices to narrow their legal matter into a form that is understandable and workable for the server system. By making these prescribed field choices the client is in effect giving the server system a series of instructions which will result in the server system processing the entered information and making computer choices to return certain information back to the client in response to their request. Many of these responses will be immediate electronic responses, and many will be responses occurring over a period, depending upon the task or service selected.

The inventive system and methods provide the client with the functionality to further chose or either request more information related to an earlier choice made or to view other services available in the Internet environment of the law firm. The client may also return to the system Web site at a later time and continue with their searches or information requests.

Although many legal services may be rendered using the system, the following more routine services are well-suited for the present invention, they include: initial questions being asked by clients, reviewing or receiving information sought by clients on consumer or other areas of law, viewing actual or sample legal documents, such as letters, leases, agreements, estate planning documents, and all types of documents that clients may wish to view.

One of the many features and advantages of the present invention is that a client will now have an alternative way to use and interact with a provider of legal services. Without the present invention, clients usually have to physically visit a law firm in person, or utilize the telephone, or various forms of letter mail or facsimile communication media to communicate their needs to lawyers. Such media often result in delays to clients in handling routine legal matters. The Internet provides an instantaneous transmission medium between users and hosts, and in the context of the present invention, the Internet will provide instantaneous transmissions for some tasks between a client and his law firm. In other cases, the present invention using in conjunction with Internet will significantly reduce the time of providing certain types of legal services.

Another feature and advantage is that the present invention will offer more than the traditional lawyer Web site utilized by many attorneys and their clients today. Typically, clients are able to access a law firm's Web site and learn about the profiles and expertise of various lawyers in the firm, along with other related biographical information. The present invention will enable clients not only to seek profile information regarding lawyers and law firms, but will additionally allow the client to electronically obtain legal services from lawyers in the firms. Some services are not Internet-friendly, and thus, these services will be performed in the traditional manner, even for law firms that are expected to have the present invention as an integral part of their office.

A further benefit and advantage of the present invention is that reduction of overhead costs, and more efficient legal services may be achieved, without compromising service quality or client confidentiality. Furthermore, clients will be additionally served because their concept of what they can obtain from their law firm will be increased markedly. Legal clients will now be able, as a direct result of the functioning of the present invention, to obtain on-line legal services in real time from law firms over an interactive network such as the Internet.

Another benefit and feature of the present invention allows legal entities to configure and customize a law office web site to meet the needs of the legal entity. The navigation paths of the web site may be configured by the legal entity with the navigation paths being stored on a database. This web site navigational path configuration provides a quick method for the legal entity to set up a customized legal services web site. Client-viewable screens of the web site may be set up to be dynamically created using the invention. This helps the legal entity create web pages without have to create hard-coded HTML files or know HTML or JAVA language programming.

Another benefit and feature of the present invention is that legal entities may create on-line legal forms that are dynamically displayed to their clients. The legal entity may create a legal fowl and chooses data fields for the client to enter. When the client selects the legal form the text of the form is presented to the client. The client then enters in information into the form. The data entered by the client is then saved on the database. The legal entity may then retrieve the form and review it and/or print it.

Another benefit and feature of the present invention is to allow legal entities to create searchable topical databases that the legal entity deems important to the legal entities area of legal practice. The topical database may be set up with various categories and subcategories of legal information.

### BRIEF DESCRIPTION OF THE DRAWINGS

The foregoing and other objects, features and advantages of the invention will be apparent from the following more particular description of preferred embodiments of the invention, as illustrated in the accompanying drawings. Wherever possible, the same reference numbers will be used throughout the drawings to refer to the same or like parts. The drawings are not meant to limit the invention to particular mechanisms for carrying out the invention in practice, but rather, are illustrative of certain ways of performing the invention. Other uses will be readily apparent to those skilled in the art.

FIG. 1 illustrates the typical hardware configure for client access to the server system;

FIG. 2 illustrates the process where the client accesses a virtual law office and requests certain legal services;

FIG. 3 illustrates the process where the client is a new firm client;

FIG. 4 illustrates the process where the client is current client and needs help with current case;

FIG. 5 illustrates the legal rights inquiry process; and

FIG. 6 illustrates the simple legal procedure process.

### DETAILED DESCRIPTION

The present invention provides a method and system for delivering certain specified legal services for clients, from licensed practicing lawyers and their law firms, over the Internet. The present invention provides communication avenues between a client and his lawyer for the performance of legal services. The following description is presented to enable any person skilled in the art to make and use the invention. Descriptions of specific applications are provided only as examples. Various modifications to the preferred embodiments will be readily apparent to those skilled in the art, and the general principles defined herein may be applied to other embodiments and applications without departing from the spirit and scope of the invention. Thus, the present invention is not intended to be limited to the embodiments shown, but is to be accorded the widest scope consistent with the principles and features disclosed herein. Reference will now be made in detail to preferred embodiments of the invention, examples of which are illustrated in the accompanying drawings.

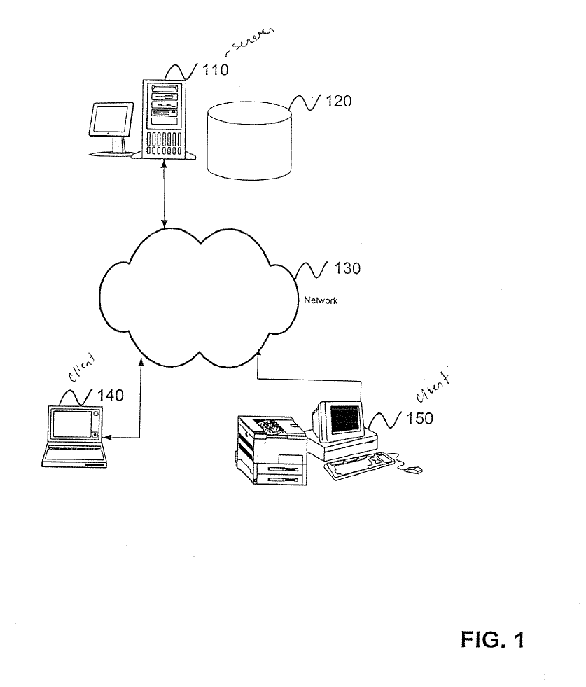

In an embodiment of the present invention, communications between a client and a legal entity take place via an electronic network. FIG. 1 illustrates an exemplary computer system used as a part of a system to render legal services in accordance with the present invention. The legal services client uses a Web browser installed on a computer 150 or laptop 140 connected to the Internet 130. Using the Web browser, the legal services client connects to the server system 110, which processes information and requests entered by the legal client via the Web browser and server-side programs residing on the server computer 110. In one embodiment, the Web browser utilizes secure and regular connections to the server computer 110, for example an server computer running Apache Web Server software. The server computer 110 includes a server engine, various web pages, and legal topical databases and a client database. The server engine receives HTTP requests to access Web pages and provides the Web pages to the various client systems 140, 150. In one embodiment of the present invention, programming languages used to develop the computer methods include HTML, Java, JavaScript, and CGI. Other programming development languages or combinations or different languages may be used to create the inventive system and computer-implemented methods, for example Python and PHP.

A database management system, commonly referred to herein as a database, is used in conjunction with the present invention for the storage and retrieval of various information captured by system interfaces, such as a user interface, or information that is manipulated by program logic. This database may be comprised of one or more different databases, residing on one or more servers. Preferably, the database is of the relationship type, although other hierarchical, n-tier or other databases capable of storing and retrieving the information used by the system may be utilized.

A relational type of database is commonly made up of tables containing records. A record usually consists of one or more fields. The fields may be of various data types and lengths. Another name for a record is a row or tuple. Tables often have fields that serve as key values that make a record unique in a table. Also, two or more tables may be joined together through the use of an intersection table or through programmatic code that will join table together based on field values.

The database used with the inventive system may reside on a single database server, or may be distributed on multiple database servers. For example, a database may be configured in such a way that the computer files that contain the data of the database, may reside on separate computer servers. Also, database data may reside logically in memory such as RAM.

Also, the database of the inventive system may be accessed from user interfaces of the present invention, either directly or indirectly, or a combination of the two. User interfaces may contain programming code that allows the user interface to directly access the database management system. Alternatively, the programming logic may interact through one or more intermediary programs which receives storage and retrieval requests. The intermediary program will handle the direct interaction to the database.

With reference to FIG. 1, portions of the systems used to facilitate the rendering of legal services are comprised of computer-readable and computer-executable instructions which reside, for example, in computer-usable media of a computer system. It is appreciated that system of FIG. 1 is exemplary only and that the present invention can operate within a number of different computer systems including general purpose computers systems, embedded computer systems, and standalone computer systems specially adapted for automatic system error analysis. A computer-usable medium may include any kind of computer memory such as floppy disks, conventional hard disks, CD-ROMS, Flash ROMS, nonvolatile ROM, and RAM.

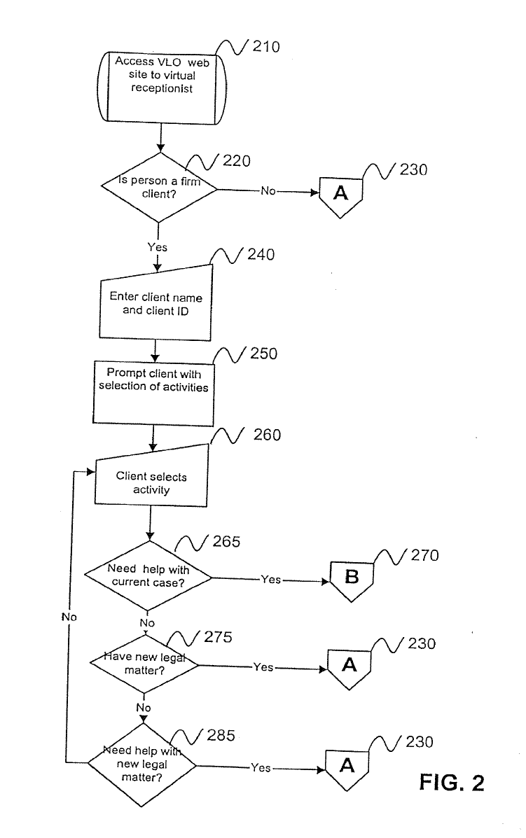

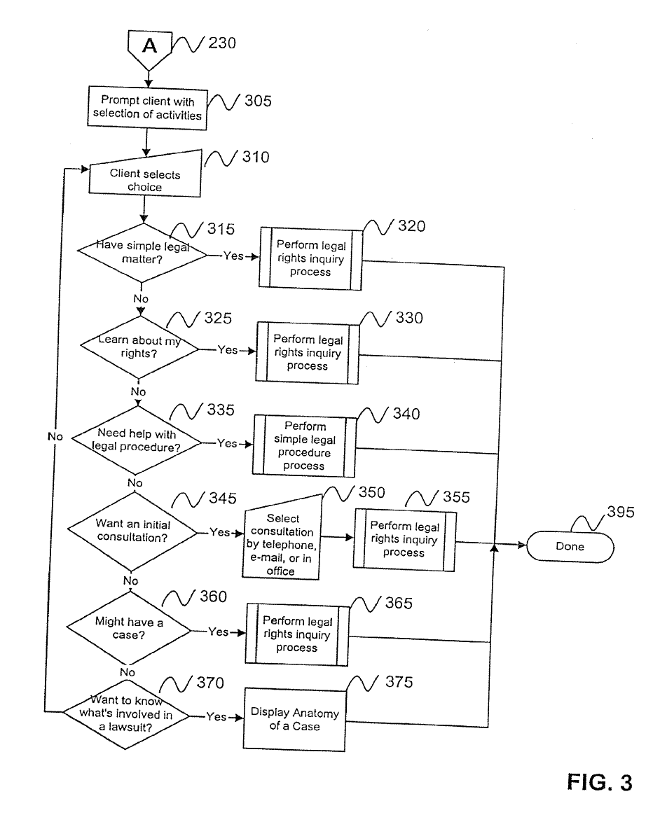

Referring to FIG. 2, in step 210 the legal services client accesses the Virtual Law Office web site. Next in step 220, the web site asks the person accessing the web site if he is a firm client. The person inputs an answer of either “Yes” or “No.” If the person is not a firm client, then they continue with step 230 which continues on FIG. 3. If the person is a firm client, then the person is prompted to enter in his name, client identifier, and password, step 240. The client name and identifier are then verified to ascertain whether the individual is a current client of the firm. In step 250, the client is then prompted with a selection of activities. In step 260, the client selects the particular activity. If the client needs help with a current case 265, then it continues with step 270. If the client has a new legal matter 275 then he continues with step 230. If the client needs help with a new legal matter then it continues with step 230.

Referring to FIG. 3, the process begins with step 230 which is continued from FIG. 2. In step 305, the client is prompted with a selection of client activities. In step 310, the client selects the from the list of activities prompted to client.

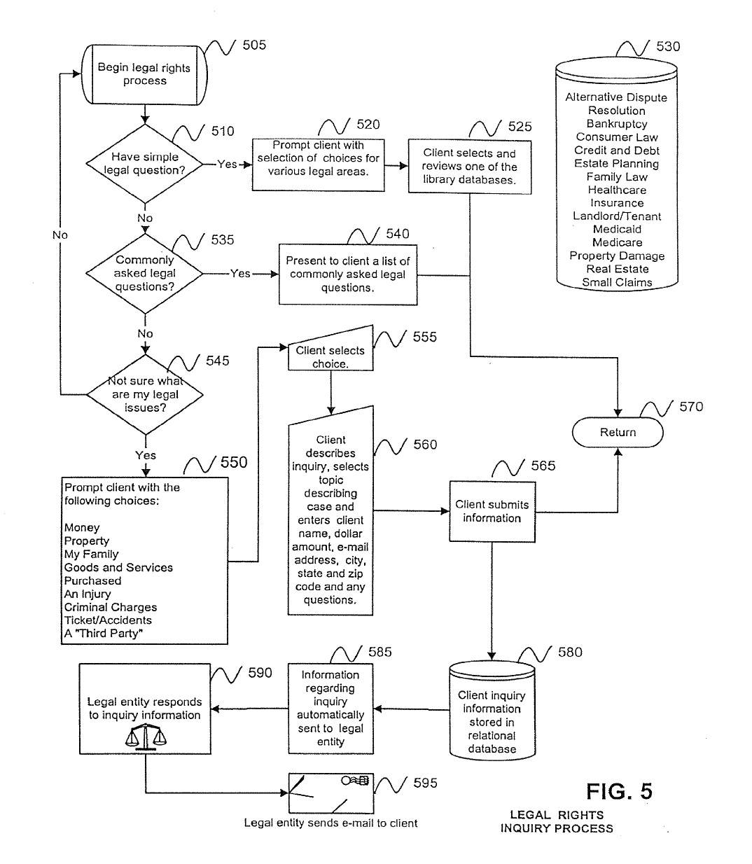

If the client selects “have simple matter” 315, then the legal rights inquiry process 320 set forth in FIG. 5 will be performed, and will return to finish at step 395.

If the client selects “learn about my rights” 325, then the “perform legal rights” inquiry process 330 set forth in FIG. 5 will be performed, and will return to finish at step 395.

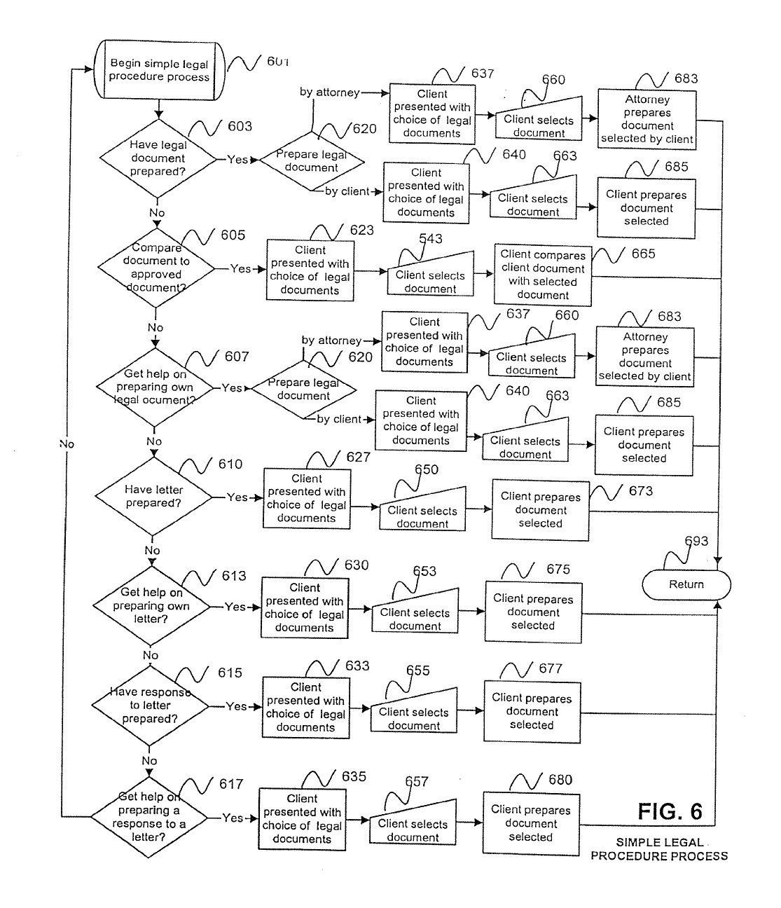

If the client selects “need help” with legal procedure 335, then the “perform simple legal procedure” process 340 set forth in FIG. 6 will be performed, and will return to finish at step 395.

If the client selects “want an initial consultation” 345, then the client is prompted to make a selection of which method to use: the client may select consultation by telephone, e-mail or in-office. In one embodiment, the request for consultation is then sent to the legal entity via e-mail with the type of request. The attorney then responds to the e-mail request by sending an e-mail confirming the consultation type. In an alternative embodiment of the present invention, the selection of the consultation type is stored on a central or distributed database, where the attorney will retrieve information concerning the consultation type selected by the client. Before or after the consultation type is selected, the client is prompted with the payment amount for the service. Additionally, a screen will be displayed to allow the client to enter in credit/debit card, checking account information, or other common payment methods for charges related to a consultation. The client's submission of the consultation request will authorize charges to the credit/debit card or checking account. Next, the legal rights inquiry process 355 as set forth in FIG. 5 will be performed, and the process will return to and finish at step 395.

If the client selects “might have a case” 360, then the “legal rights inquiry” process 365 is performed. Before or after the “legal rights inquiry” process 365 is performed, the client is prompted with the payment amount for the service. Additionally, a screen will be displayed to allow the client to enter payment information; namely credit/debit card information for charges related to the service. The client authorizes charges to the credit/debit card. The process will return to and finish at step 395.

If the client selects “want to know what's involved in a lawsuit” 370, then client is presented with the “Anatomy of a Case” 375 which displays to the client information pertaining to a type case.

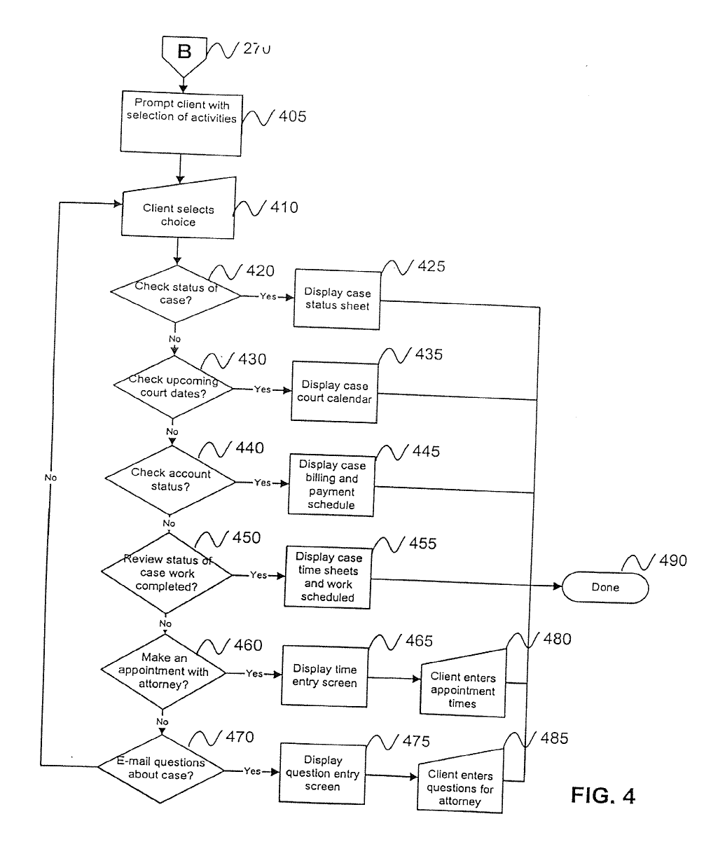

Referring to FIG. 4, the process begins with step 270 which is continued from FIG. 2. In step 405, the client is prompted with a selection of activities. Next in step 410, the client selects the activity choice.

If the client selected “check status of the case” 420, then the case status sheet will be displayed 425; the step will continue to the end of the process ending at step 490. This case sheet information is preferably stored on a central database and retrievable by the client through the web site.

If the client selected “check upcoming court dates” 430, then the court calendar will be displayed in step 435. The court calendar will identify dates unique to the client's case where the client's attorney and/or the client must submit pleadings or documents to the court and/or be present at a court for hearings or for trial; the step will continue to the end of the process ending at step 490.

If the client selected “check account status” 440, the case billing and payment schedule will be displayed; the step will continue to the end of the process ending at step 490. The account status, case billing and payment schedule will preferably be stored on a central database and retrievable by the client through the web site.

If the client selected “make an appointment with attorney” 460, then a screen will be displayed 465 for the client to enter in an appointment time with the client's attorney 480. The appointment time will be preferably sent to the client's attorney via e-mail. However, the appointment time may be alternatively stored on a central or distributed database where the attorney may retrieve the appointment infoiniation. Step 480 will continue to the end of the process ending at step 490.

If the client selects “e-mail questions about the case” 470, then a screen is displayed where the client may enter information regarding the client's question 475. The client may then enter questions for the attorney 485. In one embodiment, the questions are then sent to the client's attorney via e-mail where the questions are answered and sent via e-mail to the client. However in an alternative embodiment, the questions may be stored on a central or distributed database. The questions are then accessible to the attorney. The attorney answers the questions and the answers are stored on the database. The client may then retrieve from the database the answers to the client's questions. Step 485 will continue to the end of the process ending at step 490.

Referring to FIG. 5, the legal rights process begins 505 and the invention prompts the client to select from a list of questions. If the client selects “Have a simple legal question” 510, then the client is prompted with a selection of choices for various legal areas 520. The client then selects 525 one of the legal areas and then information pertaining to the legal area is displayed. In one embodiment, the library database 530 consists of HTML pages that are displayed to the client upon selection of the legal area. The library database 530 may contains information regarding the following area: Alternative Dispute Resolution, Bankruptcy, Consumer Law, Credit and Debt, Estate Planning, Family Law, Healthcare, Insurance, Landlord/Tenant, Medicaid, Medicare, Property Damage, Real Estate, and Small Claims. Other database topics may be added, or database topics may be removed. In one embodiment of the invention, the contents of the library database 530 are stored in tables of a relational database system. Upon selection of a legal area, the relational database is queried and records pertaining to the legal area are then formatted and presented to the client through the web browser. The client using his web browser may then scroll through the resultant information. The process then returns 570 after the step that initiated the legal rights process.

In one embodiment, the invention stores in a relational database system table(s), information pertaining to the legal areas selected by the client. The legal entity may then execute and review reports that query from this table(s). For example, the report may show that a client selected the legal area of “Medicaid.” The legal entity reviewing the report may then send additional information to the client about the legal area of interest, in the present example “Medicaid.” Further, the legal entity may generate reports to summarize the total number of legal areas that clients have in the past selected. For example, a report may be run to determine the number of “hits” that a particular legal area receives out of the total number of hits for a period of time; daily, weekly, monthly, etc. This hit ratio provides valuable information to the legal entity in evaluating the areas of interest of its clients. If a high hit ratio exists for a particular legal area, then the legal entity concentrates its efforts in the area of interest. Additionally, if the legal entity wants to be immediately notified of a selection by a client, the legal entity may identify the areas for which it wants to be notified by tagging a field for a particular legal area(s). Upon the client's selection of the area for which the legal entity tagged, an e-mail would automatically be sent to the legal entity identifying the client selecting the legal area. Alternatively, in a screen viewable only to the legal entity, information relating to the selections by the clients may be reviewed.

If the client selects “Commonly asked legal questions” 535, then a list of questions and respective answers are presented to the client 540. The list of questions may be stored as an HTML file on the web site server. In one embodiment of the invention, the list of questions and their answers are stored in a relational database system. The relational database system queries a table containing the legal questions and answers and then the results of the query are formatted and electronically presented in a manner readable to the client. The client using his web browser may then scroll through the resultant information. Similar to the selection of legal areas of interest by the client 520, in one embodiment, statistical information to the question and answers selected by the client is stored in a relational database system table(s). Reports, automatic notification, and review of information selected by the client may be reviewed by the legal entity.

If the client selects “Not sure what are my legal issues” 545, then the client is prompted with a main category of choices 550 including the following: Money, Property, My Family, Goods and Services, Purchased, An Injury, Criminal Charges, Tickets/Accidents, A “Third Party.” Then the client selects from the list of choices 555 that is of interest to the client. Upon selection of the main category, the client is presented with subcategories. The Category and subcategories that may be selected by the client, the Categories and subcategories may be updated or changed by the legal entity. The following list shows exemplary Categories and subcategories that may be utilized with the inventive system:

Family
My children
My spouse
My grandparents
My grandchildren
Other relatives

Property
I am a landlord
I am a tenant
I am purchasing land or a home
I need help with a non-real estate transaction
Other

Money
Bankruptcy
Credit
Collection agencies
Disputed bills
Collecting money owed to me
Other

An Injury
Auto accident
Injury on someone else's property
I/my family was injured
Injury on my property
Other relatives

Goods/Services I Purchased
Home remodeling/repairs
Auto repair
Goods or services purchased
Selling goods or services
Other

Criminal
DUI/DWI
Other felony
Other misdemeanor
Other

Traffic Tickets and Accidents
Moving violation
Other ticket
Non-injury accident
Other

A Third Party
Neighbor
Landlord
Tenant
Roommate
Co-worker
Retailer
Contractor
Creditor
Collection Agency

In one embodiment of the invention, a file written in the PHP language resides on the web site server and is presented to the client 550 via a program interface. The Categories are hyper-linked to other web pages, also residing on the web site server, which contain the selectable Subcategories. In another embodiment, the list of Categories is stored in a relational database system table(s). In step 550, the Category table is queried and then a screen is dynamically created which presents to the client the available Categories for selection. Additionally, the subcategories are also stored in a relational database system table(s). Upon selection of a Category by the client, the subcategory table is queried and then a screen is dynamically created which presents to the client the available subcategories for selection.

The client then selects the subcategory 555. Then the client in the next step 560 is presented with a screen where the client may input information that describes the inquiry. Additionally, the client may select the topic describing the case, enters the client name, dollar amount, e-mail address, city, state, and zip code. The client may also enter any questions for the legal entity. After the information is inputted by the client, the client submits the information 565. The process then returns 570 after the step that initiated the legal rights process.

After the client submits the information 565, the information is preferably stored in a relational database system 580. In one embodiment, the information entered by the client in step 560 is then sent automatically to the legal entity by e-mail 585. Upon receipt of the e-mail the legal entity responds to the inquiry 590. The legal entity then sends an e-mail to the client in response to the clients inquiry 595. In one embodiment, the information stored in the relational database system is retrievable by the legal entity through a screen accessible only by the legal entity. The legal entity may query the database to determine if any requests have been made by a client. If so, then the legal entity may review the client inquiry information.

Referring to FIG. 6, the simple legal procedure process begins 601 and the client is prompted to select from a list of questions. If the client selects “Have a legal document prepared?” 603, then the client can choose who will prepare the document 620. If the client chooses the attorney to prepare the legal document, then the client will be presented with a choice of legal documents that the client wants the attorney to prepare 637. The client selects the legal document 660. Information fields pertaining to the legal document may then be entered by the client. For example, if the legal document is a Will, the client will be required to complete, to the best of his ability, the fields on the Will form. The Will fields may include such information as name, address, executor, assets, and beneficiary. Additionally, the client may enter in pertinent facts that are relevant to the client's particular legal situation. The chosen document is then sent to the attorney for his/her preparation. The preferred embodiment is to send the chosen document to the attorney via e-mail. In one embodiment, information pertaining to the client's selected document is stored on a relational database system. This information includes the client identifier, the document selected and any document-specific information entered by the client. The legal entity may then later retrieve the document from a screen viewable only to it. The legal entity will then review the legal document in conjunction with the document form fields entered by the client. Then it will prepare the document and send to the client's e-mail address with instructions for the document's execution.

The legal documents have fields which capture information specific the legal document form. The client enters information to a specific field on a foul'. In one embodiment, the library database is queried and information either pertaining to the legal document in general is sent to the client via e-mail. An alternative embodiment will dynamically create a pop-up window that questions whether the client wants to view information pertaining to the legal topic. If so, then steps 520, 525 and 570 in FIG. 5 are performed.

The client may also choose to prepare the document himself. If so, then the client is presented with a choice of legal documents 640. Then he selects the legal document that he wants to prepare 663. The client then enters into the legal document form necessary information to create the legal document 685. The process then returns 693 after the step that initiated the simple legal procedure process.

If the client selects “Compare document to approved document?” 605, then the client is presented with a choice of legal documents that he wants to compare 623. The client then selects the document 543. Two of many different documents selectable by the client are Financial and Estate Planning documents. These documents are filled out on-line by the client to assist the attorney in determining how to best assist the client. The document that he selected is then displayed to the client. The client then compares his document with the selected document 665. The process then returns 693 after the step that initiated the simple legal procedure process.

If the client selects “Get help on preparing own legal document?” 607, then the same process is followed as when the client selects “Have legal document prepared?” 603. The process then returns 693 after the step that initiated the simple legal procedure process.

If the client selects “Have letter prepared?” 610, then he is presented with a choice of legal documents 627. The client then selects the legal document 650. The client then prepares the legal document 673. The process then returns 693 after the step that initiated the simple legal procedure process.

If the client selects “Get help on preparing own letter?” 613, then he is presented with a choice of legal documents 630. The client then selects the legal document 653. The client then prepares the legal document 675. The process then returns 693 after the step that initiated the simple legal procedure process.

If the client selects “Have response to letter prepared?” 615, then he is presented with a choice of legal documents 633. The client then selects the legal document 655. The client then prepares the legal document 677. The process then returns 693 after the step that initiated the simple legal procedure process.

If the client selects “Get help on preparing a response to a letter?” 617, then the client is presented with a choice of legal documents 635. He then selects the legal document 657. The client then prepares the legal document 680. The process then returns 693 after the step that initiated the simple legal procedure process.

Another aspect of the invention is the ability of the legal entity to customize the web site navigation path for clients. The legal entity may configure the web site to closely follow the legal entity's practice areas. For example, using a user program interface, the legal entity enters the navigation paths for the client which may be stored on the database. The legal entity enters into the screen a description of the legal services or activities. Next the legal entity links the entries to internal or external web pages on the web site. The linked web pages may be static web pages (that is, web pages that do not change) or dynamically created web pages. This information is then stored on the database. For example, a legal entity may enter into the screen the following:

| PageName | Description | LinkTo | Type |
|---|---|---|---|
| ReceptionistPage1 | What services do you provide? | QuestionServices1 | Question |
| ReceptionistPage1 | Draft me a Will | WillsPage1 | Dynamic |
| WillsPage1 | How much does it cost? | QuestionWills1 | Question |
| WillsPage1 | Other Will information | Http://www. | External |
| WillsPage1 | Draft a Will | WillForm1 | Form |

The PageName is an identifier for the web page where the contents of the field Description will be displayed. The LinkTo field identifies where the page will navigate to when the hot link is clicked. The LinkTo field can be a static or dynamic web page within the web site or an external web site with the URL or web site address identified.

The Type is the type of destination web page that is linked to. If the type is a Question, then the database is queried to find a question tag identifier in the database, matching the LinkTo field entry. If a match is found, then the answer to the question is displayed to the client. If no match is found, then a screen is displayed indicating no answer is on file. If the type is Dynamic, then this indicates that the hot link will link to a dynamically created web page. If the type is Static, then this indicates that the hot link will link to a static web page. If the type is External, then this indicates that the hot link will link to an external web site. If the type is Form, then this indicates that the form specified will be presented to the client? If the type is to Database, then a search tool is displayed for the particular topic or category of the database.

Once the information is stored in the database, the client can access the web site. The web site is configurable as to what page the client first accesses. Using the example data above, ReceptionistPagel will be set up as the first accessible page. In other words, ReceptionistPagel is first seen by the client when accessing the web site. The web site will read the database table and dynamically create a list of “hot links” that the client may select. Using the present example, the following would be displayed:

What services do you provide?

Draft me a Will

If the client selects “What services do you provide?,” then the database is read. Referring to the table with information entered by the legal entity, the LinkTo field is “QuestionServicesl.” The web site will then search the questions and answers database for a question with a question tag identifier “QuestionServicesl.” The answer to the question will then be presented to the client.

If the client selects “Draft me a Will,” then the database table is read, and a screen is dynamically created displaying the following information:

How much does it cost?
Other Will information
Draft a Will

If the client selects “How much does it cost?,” then the database is read. Referring to the table with information entered by the legal entity, the LinkTo field is “QuestionWills1.” The web site will then search the questions and answers database for a question with a question tag identifier “QuestionWills1.” The answer to the question will then be presented to the client. If the client selects “Other Will information,” then the client will be sent to an external web site address identified in the LinkTo field. If the client selects “Draft a Will,” then database will be read for a form with the tag identifier of “WillFoinil.” Then the form, in this case WillForm will be presented to the client to be filled out on-line.

Legal forms may be created by the legal entity and stored on the database. The legal entity drafts the form by entering into a screen the text of the form. The legal entity then selects data fields that must be entered in by the client. The legal form and data fields that are to be entered by the client are then saved on the database with the form tag identifier. For example, when creating a standard Will form, the legal entity drafts the legal form. Then the legal entity selects the positions where the client needs to input information. The positions of the data fields and text of the legal form are then stored on the database. When the client accesses the form, the client is presented with the form and inputs information into the data fields.

Questions and answers may be set up using a user program interface. The legal entity enters a category for the question, inputs the question, and then inputs an answer to the question. Also, a question tag identifier may be entered for the question. The question tag identifier is used by the web site with the navigation tool. The information is then saved onto the database. For example, the legal entity selects the category “Wills,” and then enters a question such as “How do I probate a will?,” a question tag identifier “QuestionWills1” and then enters an answer to the questioned entered. The questions and answers may then be searched by the client using screens wherein he enters in his search terms. Alternatively, the list of questions for a particular category may be dynamically listed to the client. The client then selects the questions that he wants answered and the answer to the question is retrieved from the database and displayed to the client.

A topical or legal area database may also be created by the legal entity. The legal entity enters into a screen, a topic or category. A topic or category tag identifier is also inputted. Then information pertaining to the topic or category is entered. The legal entity may use the screen to update or delete the contents of the topic or category database. A topic or category tag is also created. The information is then stored on the database. When the topic or category database is navigated to, then a dynamically created screen is displayed listing the information pertaining to the category or topic. Additionally, the resulting topical or categorical database may be searched using a search screen where the client enters in search criteria.

Payment for services can be configured by the legal entity. For each client navigable screen the legal entity may require that payment for services be made by the client. For example, the category or topic database may be configured to be pay for search. The tag identifier for the topical or categorical database will be entered into a “Pay for Service” table. Before the client is presented with a navigable screen, the “Pay for Service” table is queried. If the LinkTo screen name is in this table, then a dynamic screen will be created identifying the service and that a payment is required. The amount of the transaction will be displayed. Payment options will be presented to the client wherein the client makes a selection of the payment option and authorizes charges. The payment options include credit card and debit card. The client enters in required account and address information and then the transaction is processed. The LinkTo screen will then be displayed.

The communications method to the legal entity is also configurable. The legal entity selects if it wants communications via the web site to be made to the legal entity via direct e-mail or wants to receive correspondence directly through the web site. For example, the web site may automatically send correspondence to the e-mail address set up by the legal entity. Or the correspondence may be saved on the database where the legal entity may retrieve from any Internet accessible web browser, a secured screen where the legal entity may review the client's correspondence to the legal entity. Additionally, the legal entity may select the option to notify it when correspondence is saved on the web site.

The various embodiments described above are provided by way of illustration only and should not be construed to limit the invention. Those skilled in the art will readily recognize the various modifications and changes which may be made to the present invention without strictly following the exemplary embodiments illustrated and described herein, and without departing from the true spirit and scope of the present invention, which are set forth in the following claims.

1. A computer system for facilitating legal services between a legal entity and a client, said system comprising:
a first user station operable by a client for communicating a first set of client need information;
a second user station operable a by a legal entity for communicating a set of legal entity advice information, said second user station being remote from said first user station;
an intermediary server being configured for remote operation with said first user station and said second user station; and
at least one database interconnected with said intermediary server; said database having a data structure for storage of said client need information and legal advice information.

2. The computer system of claim 1, wherein said first user station includes a program interface adapted for the display and selection of legal services.

3. The computer system of claim 1, wherein said second user station includes a program interface adapted for the creation of electronic legal forms having a data field template; and wherein said database includes a data structure for storage of said electronic legal forms.

4. The computer system of claim 1, wherein said second user station includes a program interface adapted for the creation of navigation path records.

5. The computer system of claim 1, wherein said first user station includes a program interface adapted for the search and retrieval of legal topic information from said database.

6. (canceled)

7. (canceled)

8. (canceled)

9. (canceled)

10. A computer system for facilitating legal services between a legal entity and a client, said system comprising:
a verification module adapted for receipt of a client identifier from a client and authentication of said client identifier;
a legal services module adapted for display of one or more available legal services and receipt of selection of said one or more legal services; and
a database for storage of a client selection of said one or more legal services.

11. The computer system of claim 10, further comprising a payment module for receipt of payment information from said client.

12. The computer system of claim 10, further comprising a legal topical search module adapted for search and display of legal topical information from said database.

13. The computer system of claim 10, further comprising a legal forms module for presentation of one or more electronic legal forms to said client, said one or more electronic legal forms adapted for entry of data by said client.

14. The computer system of claim 13, wherein said legal forms module is adapted for storage of said client-entered data onto said database.

15. The computer system of claim 10, further comprising a navigation configuration module adapted for customization of a web site navigation path.

16. A computer-implemented method for performing legal services for clients over a network, said method comprising the steps of:
providing an interactive legal services system, including a client program interface operable by a client, an legal entity program interface operable by a legal entity, wherein said client program interface is remotely operable from said attorney program interface, an intermediary server being configured for remote operation with said client program interface and said attorney program interface, and at least one database interconnected with said intermediary server;
at said client program interface, receiving an access identifier; and
at said intermediary server, authenticating said access identifier.

17. The computer-implemented method of claim 16, wherein the step of performing a legal service comprises the steps of:
at the client program interface, displaying a list of one or more available legal services,
receiving a selection of said one or more available legal services from said client, and performing a legal service by said legal entity for said client.

18. The computer-implemented method of claim 17, wherein the step of performing a legal service comprises the steps of:
displaying a legal form to said client, said legal form having data fields for collection of information from said client;
receiving into said data fields, one or more client-specific data;
storing said one or more client-specific data into said database, said database having a data structure adapted for storing said one or more client-specific data; and
reviewing said one or more client specific data by said legal entity.

19. The computer-implemented method of claim 17, wherein the step of performing a legal service comprises the steps of:
entering by said client into said client program interface an inquiry about a legal matter, wherein said inquiry is directed to said legal entity;
storing said inquiry into said database, said database having a data structure adapted for storing said inquiry;
remotely retrieving by said legal entity via said legal entity program interface, said inquiry from said database;
entering an answer responsive to said inquiry, by said attorney;
storing said answer into said database, said database having a data structure adapted for storing said answer; and
remotely retrieving interface by said answer via said client program.

20. The computer-implemented method of claim 16, further comprising the steps of:
at the client program interface, presenting to said client a list of legal topics, said list being retrieved from said database; and
in response to a selection of a legal topic by said client, presenting to said client said legal information associated with said legal topic.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)
